(19) United States
(12) Patent Application Publication
(10) Pub. No.: US 2019/0009850 A1
(43) Pub. Date: Jan. 10, 2019

(54) SYSTEM AND METHOD FOR MOUNTING A HANDHELD ELECTRONIC DEVICE

(71) Applicant: ANNEX PRODUCTS PTY. LTD., Prahran (AU)

(72) Inventor: Christopher Peters, Prahran (AU)

(21) Appl. No.: 15/643,194

(22) Filed: Jul. 6, 2017

(51) Int. Cl. B62J 11/00; H04B 1/3822; H04B 1/3888

(52) U.S. Cl. CPC B62J 11/00; H04B 1/3888; H04B 1/3822

(57) ABSTRACT

A system for mounting a cellular phone, the system including: an apparatus adapted for attachment to the cellular phone, a locking structure associated with the apparatus, and a mount. At one end of the locking structure the mount has a generally circular indexed head, and the other end has structure for engaging the indexed head for positioning the apparatus at a desired angle relative to the mount. The case may be adjustably positioned by releasably locking the clamp to the arm at a desired position, by releasably locking the arm to the case mount at a desired position and/or by releasably locking the case to the case mount at a desired position.

The present invention relates generally to an apparatus and method for attaching a case for a handheld electronic device to one or more objects.

### BACKGROUND

Numerous mounting apparatuses have been developed to secure cases for handheld electronic devices to a bicycle or other structure. The mounting apparatuses are typically mounted to a handle bar or the like and are releasably securable to a case for the handheld electronic device. The mounting apparatuses may permit rotation of the cases relative to the mounting apparatuses so that the cases and the handheld electronic device may be adjustably positioned relative to the mounting apparatus so that the user is more readily able to position the case and the handheld electronic device at a more convenient position for use or access during activity.

### SUMMARY

The present disclosure relates to a system for mounting a cellular phone, the system including an apparatus adapted for attachment to the cellular phone having a locking structure associated with the apparatus, and a mount. One of the locking structure and mount has a generally circular indexed head comprising a first plurality of teeth extending radially outward and the other of the locking structure and mount has a second plurality of teeth defining a circular recess for engaging the first plurality of teeth at alternative locations for positioning the apparatus at a desired angle relative to the mount. A fastener may be included for releasably locking the locking structure to the mount and the first plurality of teeth to the second plurality of teeth to maintain the apparatus at the desired angle. The mount may include a clamp and an arm having two ends, and the indexed head may be formed on the arm adjacent one of the ends. One of the arms and the clamp may have a generally circular indexed head comprising a third plurality of teeth extending radially outward and the other of the arms and the clamp may include a fourth plurality of teeth defining a circular recess for engaging the third plurality of teeth at alternative locations for positioning the arm at a desired angle relative to the clamp. A fastener may be used for releasably locking the clamp and the arm and the third plurality of teeth to the fourth plurality of teeth for maintaining the arm at the desired angle relative to the clamp. The first plurality of teeth and the second plurality of teeth may be engageable with each other adjacent one of the ends of the arm and the third plurality of teeth and fourth plurality of teeth may be engageable with each other at the other end of the arm.

The case may be adjustably positioned by releasably locking the clamp to the arm at a desired position, by releasably locking the arm to the case mount at a desired position and/or by releasably locking the case to the case mount at a desired position.

### BRIEF DESCRIPTION OF THE DRAWINGS

FIG. 1 is a perspective view of a mounting apparatus shown secured to a handle bar of a motorcycle or bicycle and to a cellular phone in accordance with an embodiment of the present disclosure;

FIG. 2 is a perspective view of a mounting apparatus of FIG. 1 shown secured to a handle bar of a motorcycle or bicycle with the cellular phone and case removed;

FIG. 3 is an exploded perspective view of the apparatus of FIG. 1 taken from one end of the mounting apparatus;

FIG. 4 is an exploded view of the apparatus of FIG. 1 taken from the other end of the mounting apparatus;

FIG. 5 is a perspective view of a mounting apparatus as shown in FIG. 1;

FIG. 6 is a perspective view of the case mount of the mounting apparatus of FIG. 1 with the lever pivoted for illustrative purposes to show some of its structure;

FIG. 7 is a top plan view of the cap of the case mount of the mounting apparatus of FIG. 1;

FIG. 8 is a side elevational view of the cap of FIG. 7;

FIG. 9 is a perspective view of the case for engaging the cellular phone.

Other aspects and advantages of the present disclosure will become apparent upon consideration of the following detailed description.

### DETAILED DESCRIPTION

The present disclosure is directed to apparatuses for attaching a handheld electronic device to a handle bar of a motorcycle or bicycle or other object or surface. While the present disclosure may be embodied in many different forms, several specific embodiments are discussed herein with the understanding that the present disclosure is to be considered only as an exemplification of the principles of the disclosure, and it is not intended to limit the disclosure to the embodiments illustrated.

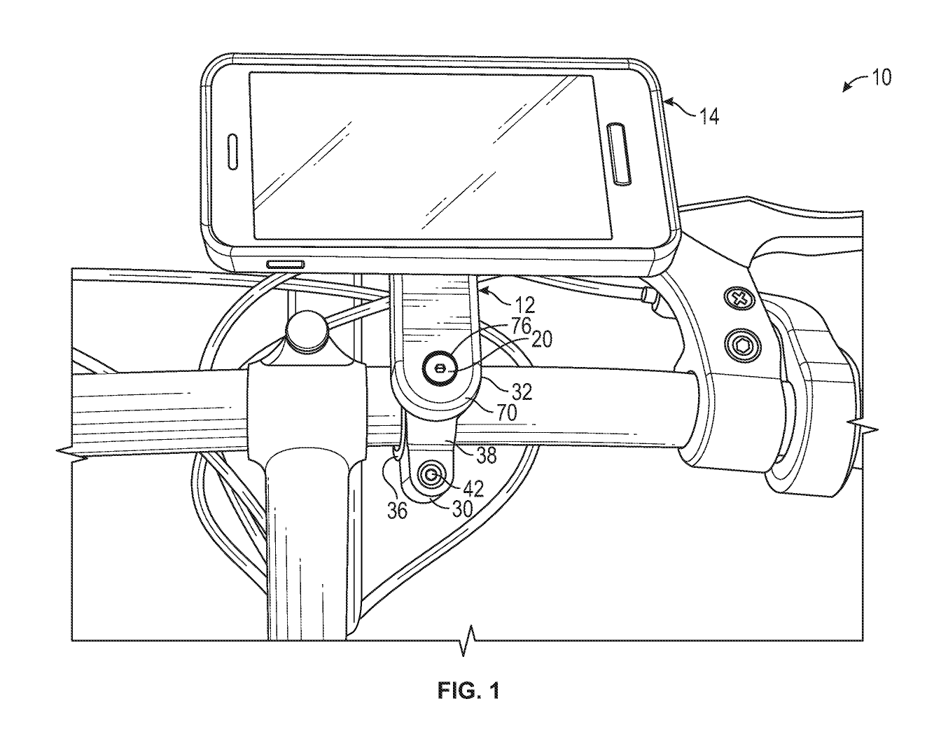

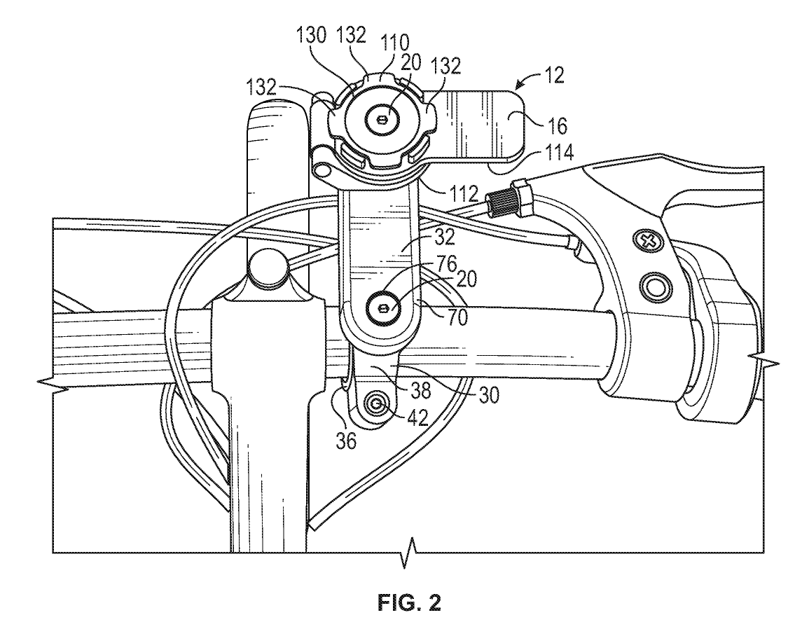

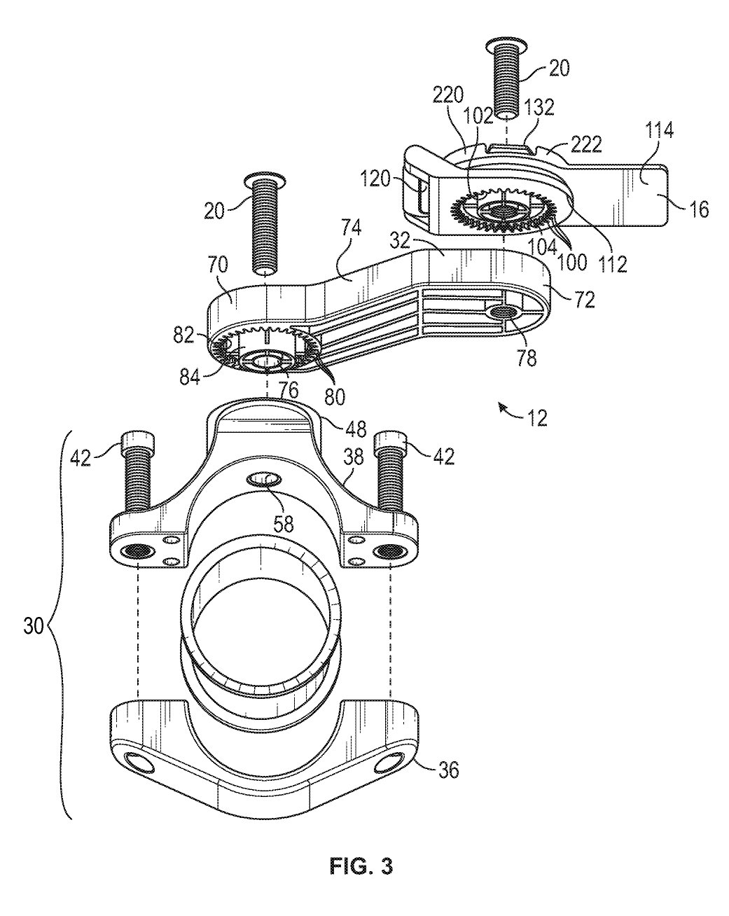

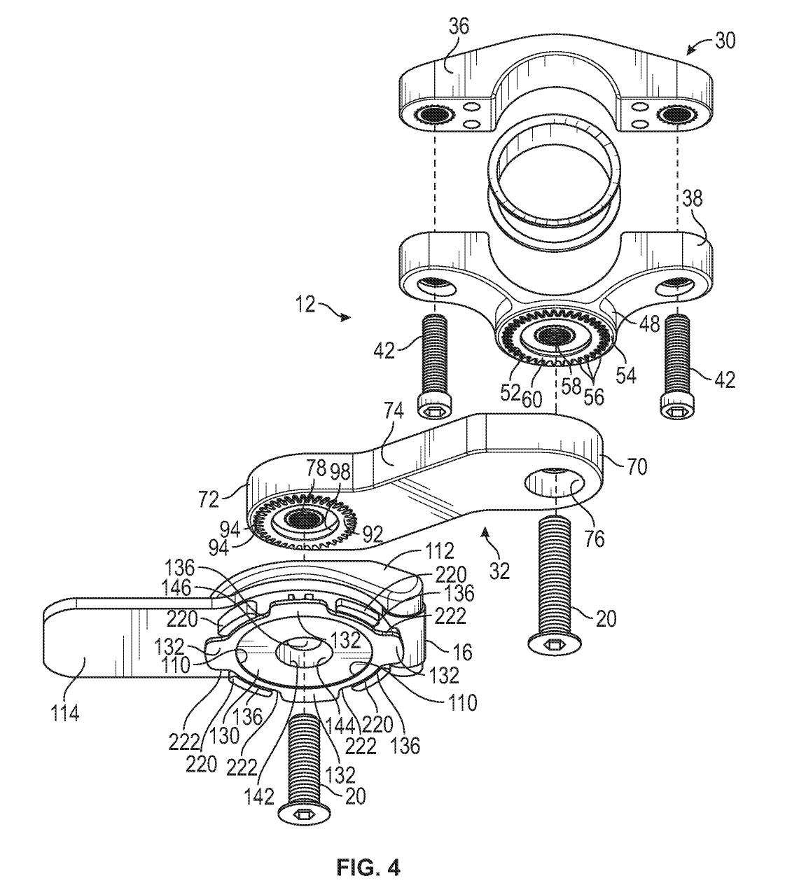

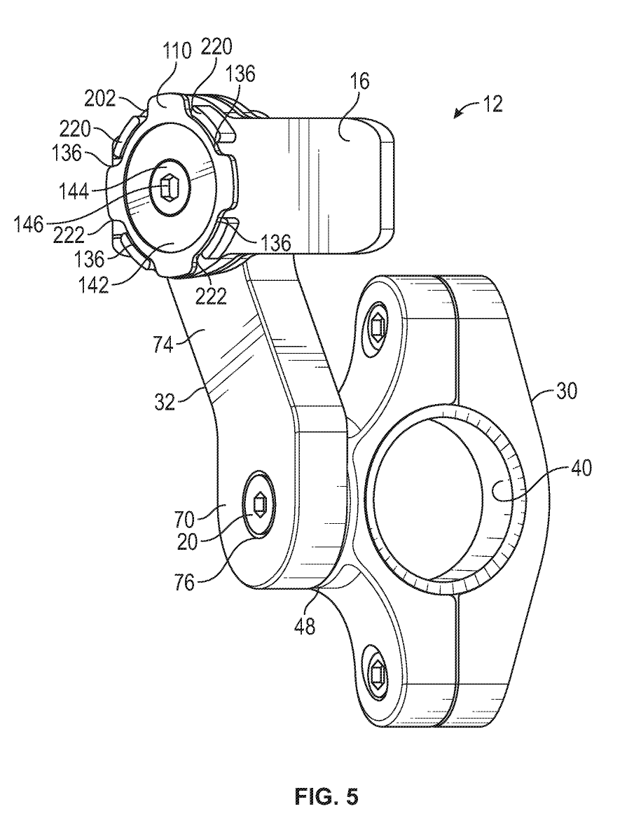

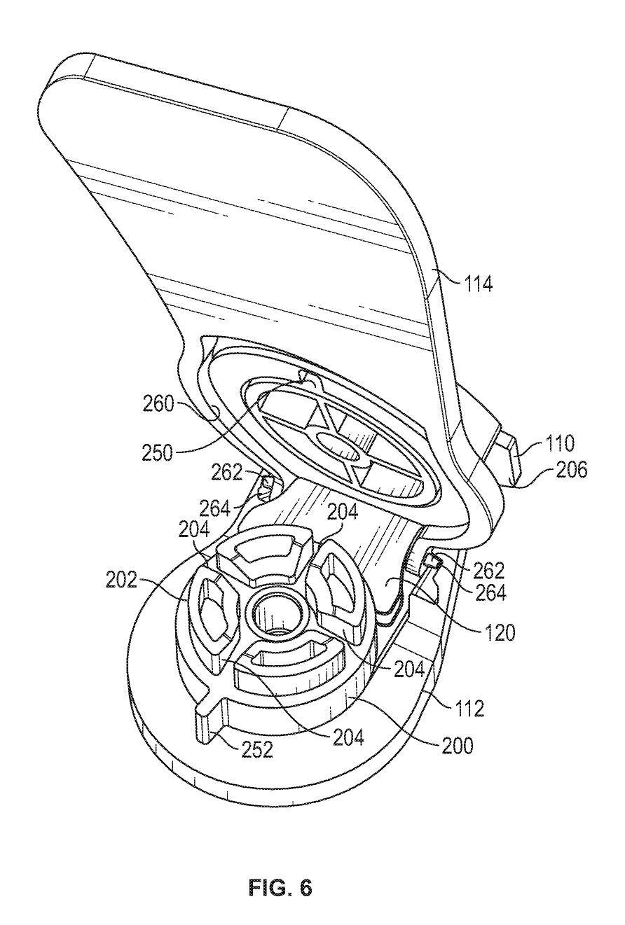

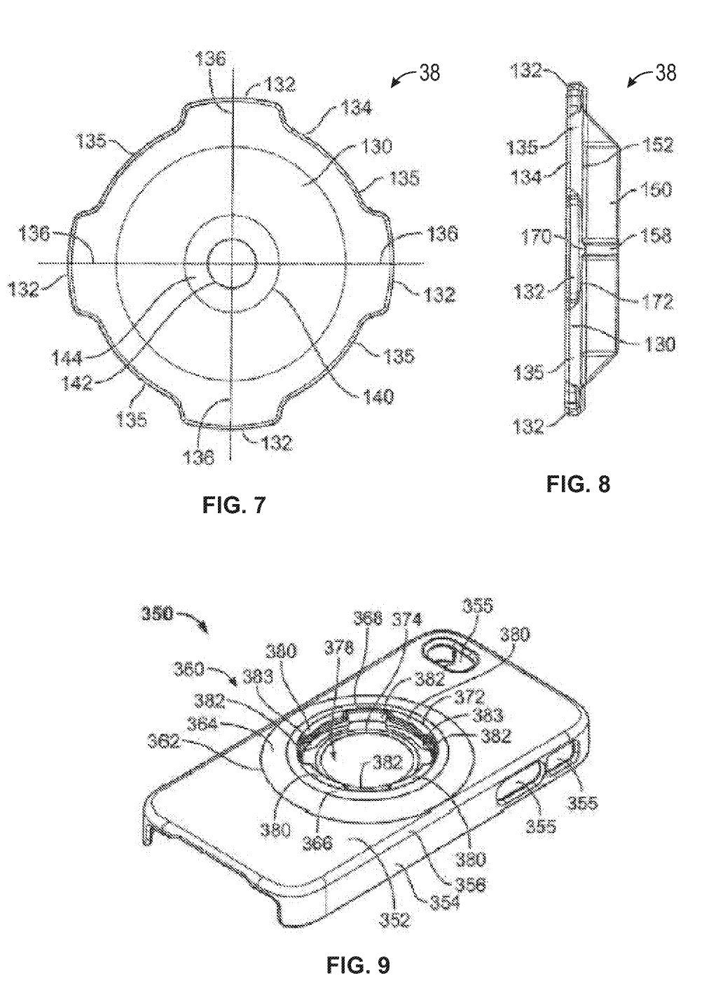

FIGS. 1-9 illustrate a mounting system and device 10 in accordance with an embodiment of the present disclosure comprising a mount 12 securable to a handle bar of a motorcycle or bicycle or the like, a case 14 securable to a cellular phone, a case mount 16 for securing the case 14 to the mount 12, and fasteners 20.

The illustrated mount 12 includes a clamp 30 and an arm 32. The clamp 30 includes a pair of c-shaped members 36, 38 that when secured together define a hole 40 for receiving the handle bar and a pair of fasteners 42 for securing the c-shaped members together about the handle bar. The c-shaped member 38 includes a mounting section 48 with a generally circular indexed head 52 comprising a circular ridge 54 and a plurality of teeth 56 extending radially outward from the circular ridge. The mounting section 48 defines an aperture 58 to receive one of the fasteners 20, and the circular ridge 54 defines a circular bore 60 disposed about the aperture.

To install the illustrated clamp 30 on the handle bar, the c-shaped members 36, 38 may be disposed about the handle bar and the fasteners 42 can be tightened by an elbow wrench or other device to releasably lock together the c-shaped members and releasably lock the clamp 30 to the handle bar. The clamp 30 may have any other suitable construction and be secured to the handle bar in any other manner in accordance with other embodiments.

The illustrated arm 32 has two ends and two end members 70, 72 and a central member 74 interconnecting the end members. The end members 70, 72 extend parallel to each other and the central member 74 extends at an angle relative to the end members 70, 72 to provide clearance from the handle bar. The end members 70, 72 define apertures 76, 78 for receiving the fasteners 20. The arm 32 includes locking structure for mounting the arm to the clamp 30. For example, one end member 70 includes a plurality of teeth 80 that defines a circular recess 82 that engages the teeth 56 of the indexed head 52 at alternate positions to engage the clamp 30 and the arm 32 at alternate positions so that the arm may be positioned at alternate angles relative to the clamp 30. The end member 70 also includes a circular plug 84 disposed about the fastener 20 that is received by circular bore 60 during engagement of the teeth 56 and the teeth 80. One of the fasteners 20 may be secured to releasably lock the teeth 56 and the teeth 80 to releasably lock the arm 32 and clamp 30 to secure the arm at the desired position.

The other end member 72 of the arm 32 includes an indexed head 90 comprising a circular ridge 92 and a plurality of teeth 94 extending radially outward from the circular ridge. The circular ridge 92 defines a circular bore 98 disposed about the aperture. The illustrated arm 32 may have any other suitable construction and be secured to the clamp 30 and case 14 or other structure in any other suitable manner.

The illustrated case mount 16 releasably and adjustably engages the case 14 and the arm 32. The case mount 16 includes locking structure for mounting the case mount to the arm 32. For example, the illustrated case mount 16 includes on its arm-engaging side a plurality of teeth 100 that defines a circular recess 102 that engages the teeth 94 of the indexed head 90 at alternate positions to engage the arm 32 and the case mount 16 at alternate positions so that the case 14 may be positioned at alternate angles relative to the arm 32. The end member 72 also includes a circular plug 104 disposed about the aperture 78 that is received by the circular bore 98 during engagement of the teeth 94 and the teeth 100. The fastener 20 may be secured to releasably lock the teeth 94 and the teeth 100 to releasably lock the arm 32 and the case mount 16 to secure the arm at the desired position. The locking structure may have any other suitable structure in accordance with other embodiments of the present disclosure.

The case mount 16 and the case 14 may be secured together in any suitable manner. For example, they may be secured together as set forth in U.S. Pat. No. 9,243,739. The case mount 16 may include a cap 110, a cap mount 112 secureable to the cap 110 by the fastener 20, a lever 114 for engaging and disengaging the case mount 16 and the case 14, and a hinge spring 120 interconnecting the lever 114 and the cap mount 112 and biasing the lever to an open position relative to the cap mount. The cap 110 includes a planar circular top wall 130 with four arcuate projections 132 extending outwardly from an edge of the top wall 130, wherein grooves 135 are formed between the arcuate projections 132. The arcuate projections 132 are disposed 90 degrees apart. A circular central section of the top wall 130 includes an angled wall 144 that tapers inwardly and downwardly leading to a circular aperture 142. The angled wall 144 generally defines an aperture 146 to receive the fastener. The fastener 20 releasably secures the cap 110 to the cap mount 112 and releasably secures the case mount 16 and the arm 32. Thus, in the illustrated embodiment the fastener 20 secures both the cap 110 to the cap mount 112 of the case mount 16 and the case mount 16 to the arm 32.

The cap 110 includes a first cylindrical wall 150 extending from a bottom surface of the top wall 130 and spaced inwardly from the edge 134 of the cap 110. A second cylindrical wall 154 further extends from the bottom surface 152 and is spaced inwardly from the first cylindrical wall 150 and spaced outwardly from the circular aperture 142. Radial support walls extend between the first and second cylindrical walls 150, 154 and are spaced 90 degrees from one another and generally aligned with the center lines 136 of the arcuate projections 132. Triangular walls 158 having an outer slanted surface 160 extend between the first cylindrical wall 150 and the edge 134 of the cap 110, wherein the triangular walls 158 are aligned with radial support walls and the center lines 136 of the arcuate projections 132. Radial elongate projections 170 extend downwardly from bottom surfaces 172 of each of the arcuate projections 132, wherein the radial projections 170 extend along the center lines 136 of the arcuate projections 132 and are aligned with the radial support walls and the triangular support walls 158.

The cap mount 112 also includes structure for engaging the cap 110 and for permitting pivoting movement of the lever 114. The cap mount 112 includes a circular wall 200 and inner circular wall 202 that define four slots 204 for receiving the radial support walls 156 of the cap 110. A wall 206 extends the height of the circular wall 200 for permitting pivoting of the lever 114.

The lever 114 includes four walls 220 spaced apart by 90 degrees and four openings 222 spaced apart by 90 degrees to receive the spaced arcuate projections 132 of the cap 110. The lever 114 includes four internal walls that define slots for receiving the triangular walls of the cap 110. Slot 250 extends through the lever 114 for engaging the wall 252 of the cap mount 112 and to permit movement of the lever 114 to disengage the case 14. The lever 114 also defines a hole 260 for receiving the circular wall 200 of the cap mount 112 also to facilitate pivoting movement of the lever 114 relative to the cap mount 112. The lever 114 is pivotally connected to the cap mount 112 by a pair of pins 262 received by openings 264 defined by the cap mount 112. In a biased position due to the hinge spring 120, the openings 222 of the lever 114 receive the spaced arcuate projections 132 of the cap 110. Pivoting of the lever 114 against the bias causes separation of the four walls 220 and the four projections 132 for engaging or disengaging the cover. The lever 114 may have any other construction in accordance with other embodiments of the present disclosure.

The illustrated case 14 includes a first wall 352 for covering a rear surface of the cellular phone. A plurality of side walls 354 extend outwardly from an edge 356 of the first wall 352, and are adapted to cover, for example, sides of the electronic handheld device. The side walls 354 may include any number of apertures 355 for accessing components of the handheld electronic device.

A circular mounting structure is disposed within a central section 362 of the first wall 352. The mounting structure 360 includes a first annular ring 364 that tapers outwardly away from the first wall 352 and a second annular ring 366 generally parallel to the first wall 352 and disposed between the first annular ring 364 and a mount 368. The mount 368 includes a cylindrical wall 370 extending perpendicular to and inwardly from an inner edge 372 of the second annular ring 366. A circular wall 374 encloses an end 376 of the cylindrical wall 370 to create a cavity 378. Four spaced arcuate projections 380 extend inwardly from the inner edge 372 of the second annular ring 366, forming grooves 382 between the arcuate projections 380. Openings 383 are disposed within the circular wall 374 opposite the arcuate projections 380. Radial grooves 384 are formed on inner surfaces 386 of the arcuate projections 380. The case 14 may have any other construction in accordance with other embodiments of present disclosure.

The case 14 of may be attached to the case mount 16 at any time during the installation. The case 14 is mounted to the cap 110 by depressing the lever 114 and aligning the grooves 382 and arcuate projections 380 of the case 14 with the arcuate projections 132 and the grooves 135, respectively, of the cap 110. A user can then rotate the case 14 until the arcuate projections 132 are aligned with the arcuate projections 380 of the case 14 and the desired positioning of the case 14 is achieved. The lever 114 is then returned to its biased position. This allows the arcuate projections 132 of the cap 110 to enter the grooves 382 of the case 14, and the arcuate projections 380 snap into the grooves 382 of the case 14 against the bias of the hinge spring 120, preventing rotation of the case 14. In this position, the radial elongate projections 170 of the cap 110 are disposed within the radial grooves 384 of the case 14 to further aid in preventing rotation of the case 14 without engaging the lever 114 against the bias of the hinge spring 120. In order to remove the case 14, the lever 114 is depressed against the bias of the hinge spring 120 while rotating the case 14 until the arcuate projections 132 of the cap 110 are aligned within the grooves 282 of the case 14. Thus, with this structure, the case 14 can be releasably locked to the case mount 16 in four different positions. The case 14 and the case mount 16 can be releasably locked together in any other suitable manner in accordance with other embodiments. The case 14 and mount 16 may have any other structure and may be secured together in any other manner in accordance with other embodiments of the present disclosure.

As set forth above, with the illustrated embodiment, one end of the arm 32 is releasably lockable with the clamp 30 at alternate positions and the other end of the arm 32 is releasably lockable with the case mount 16 at alternate positions. As a result, the securing of the clamp 30 to the arm 32 and the arm to the case mount 16 provides two different manners of adjusting the positioning of the case 14 and therefore the cellular phone received by the case. In addition, the design of the case mount 16 and case 14 may allow the case to be adjusted relative to the case mount 16, providing another manner in which the case and cellular phone can be adjustability positioned.

In securing the cellular phone to the handle bar, the order of securing the clamp 30 to the handle bar, releasably locking the clamp and the arm 32, releasably locking the arm to the case mount 16, releasably mounting the case 14 to the case mount 16, and engaging the cellular phone and the case mount 16 can occur in any order.

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

1. A system for mounting a cellular phone, the system including:
an apparatus adapted for attachment to the cellular phone, the apparatus having a locking structure; and
a mount releasably lockable with the locking structure, one of the locking structure and the mount having a first circular indexed head comprising a first plurality of teeth extending radially outward and the other of the locking structure and mount having a second plurality of teeth defining a circular recess for engaging the first plurality of teeth at alternative locations for positioning the apparatus at a desired angle relative to the mount;
wherein the mount includes an arm having two ends and a clamp and wherein one of the arm and the clamp has a second locking structure and the other of the arm and the clamp has a second circular indexed head releasably lockable with the second locking structure, the second indexed head comprising a third plurality of teeth extending radially outward and the second locking structure including a fourth plurality of teeth defining a circular recess for engaging the third plurality of teeth at alternative locations for positioning the arm at a desired angle relative to the clamp.

2. The system of claim 1 further including a fastener for releasably locking the mount to the locking structure and the first plurality of teeth to the second plurality of teeth to maintain the apparatus at the desired angle relative to the mount.

3. The system of claim 1 wherein the first indexed head is disposed on the mount.

4. The system of claim 3 wherein the first indexed head is formed on the arm adjacent one of the ends.

5. The system of claim 1 wherein one end of the arm is releasably lockable with the clamp and the other end of the arm releasably lockable with the locking structure.

6. The system of claim 5 wherein the arm comprises two end members associated with the two ends and a central member interconnecting the two end members, the two end members extending generally parallel to each other and the central member extending non-parallel to the end members.

7. (canceled)

8. (canceled)

9. The system of claim 1 further including a fastener for releasably locking the clamp and the arm and the third plurality of teeth to the fourth plurality of teeth for maintaining the arm at the desired angle relative to the clamp.

10. The system of claim 1 wherein the first plurality of teeth and the second plurality of teeth are engageable with each other adjacent one of the ends of the arm and the third plurality of teeth and fourth plurality of teeth are engageable with each other adjacent the other end of the arm.

11. A system for mounting a cellular phone, the system including:
an apparatus adapted for attachment to the cellular phone, the apparatus including a locking structure; and
a mount having a first circular indexed head comprising a first plurality of teeth extending radially outward and the locking structure including a second plurality of teeth defining a circular recess for engaging the first plurality of teeth at alternative locations for positioning the apparatus at a desired angle relative to the mount;
wherein the mount includes an arm having two ends and a clamp and wherein one of the arm and the clamp has a second circular indexed head comprising a third plurality of teeth extending radially outward and the other of the arm and the clamp including a fourth plurality of teeth defining a circular recess for engaging the third plurality of teeth at alternative locations for positioning the arm at a desired angle relative to the clamp.

12. The system of claim 11 further including a fastener for releasably locking the first plurality of teeth to the second plurality teeth to maintain the apparatus at the desired angle relative to the mount.

13. (canceled)

14. (canceled)

15. The system of claim 11 wherein the first plurality of teeth and the second plurality of teeth are engageable with each other adjacent one of the ends, the third plurality of teeth and fourth plurality of teeth are engageable with each other adjacent the other end.

16. A system for mounting a cellular phone, the system including:
an apparatus adapted for attachment to the cellular phone;
a mount including an arm and a clamp, the arm including first structure for adjustably engaging the apparatus for positioning the apparatus at a first desired angle relative to the arm, the arm and the clamp including second structure for adjustably engaging the arm and the clamp for positioning the arm at a second desired angle relative to the clamp,
wherein one of the first structure and the clamp has a first circular indexed head comprising a first plurality of teeth extending radially outward and the other of the first structure and mount including a second plurality of teeth defining a circular recess for engaging the first plurality of teeth at alternative locations for positioning the apparatus at the first desired angle; and
wherein one of the arm and the second structure has a second circular indexed head comprising a third plurality of teeth extending radially outward and the other of the arm and the second structure including a fourth plurality of teeth defining a circular recess for engaging the third plurality of teeth at alternative locations for positioning the apparatus at the second desired angle.

17. The system of claim 16 further including a fastener for releasably locking the apparatus and the arm at the first desired angle.

18. The system of claim 16 further including a fastener for releasably locking the arm and the clamp at the second desired angle.

19. (canceled)

20. (canceled)

21. The system of claim 16 wherein the arm has a pair of ends, the first plurality of teeth and the second plurality of teeth engageable with each other adjacent one of the ends and the third plurality of teeth and fourth plurality of teeth engageable with each other adjacent the other end.

22. The system of claim 1 wherein the first indexed head is disposed on the arm adjacent one of the ends of the arm and the fourth plurality of teeth is disposed on the arm adjacent the other end of the arm.
